(19) United States
(12) Patent Application Publication
(10) Pub. No.: US 2012/0321411 A1
(43) Pub. Date: Dec. 20, 2012

(54) Anchor Screw

(76) Inventors: Richard Podesser, Buchloe (DE); Arne Echterbruch, Kaufering (DE); Lothar Schwalbach, Scheuring (DE)

(21) Appl. No.: 13/524,706

(22) Filed: Jun. 15, 2012

(30) Foreign Application Priority Data
Jun. 16, 2011 (DE) 102011077595.1

(51) Int. Cl. F16B 25/10; B23P 11/00; F16B 23/00

(52) U.S. Cl. 411/387.4; 29/525.01

(57) ABSTRACT

In a self-tapping anchor screw for application in mining, tunnel construction, above-ground or below-ground construction, and for screwing into rock or into a building, comprising a screw shaft, which comprises a frontal end and a rear end, a drill head embodied at the frontal end of the screw shaft, a self-tapping thread to fasten the anchor screw in a bore hole implemented by the drilling head, the anchor screw allows cost-effective production with little technical expense and reliable fastening. The anchor screw comprises a fastening element as a separate component complementing the screw shaft and the self-tapping thread is embodied at the fastening element.

### CROSS-REFERENCE TO RELATED APPLICATIONS

The present application claims priority to German Patent Application DE 10 2011 077 595.1, filed Jun. 16, 2011, and entitled “Ankerschraube” (“Anchor Screw”), which is hereby incorporated by reference in its entirety.

### BACKGROUND OF THE INVENTION

The present invention generally relates to an anchor screw and a method for fastening an anchor screw.

Anchor screws are used for various technical applications in order to fasten the anchor screw to an object. For example, anchor screws may be fastened in above-ground construction at walls made from concrete or in tunnel construction an object may be fastened in adjacent rock using an anchor screw. For this purpose, first a bore hole is entered using a drill into the material, for example rock or concrete, and subsequently the anchor screw is screwed into the bore hole using a self-tapping thread, with the diameter of the self-tapping thread being greater than the diameter of the bore hole so that the self-tapping thread itself cuts into the material and creates a form-fitting connection between the material and the self-tapping thread. However, here two processing steps are required, namely the insertion of the bore hole using a drill and subsequently the insertion of the anchor screw.

Deviating therefrom, self-drilling anchor screws are also known which comprise a drilling head at the screw shaft. Using these self-drilling anchor screws with the help of the drilling head at a frontal end of the screw shaft a bore hole may be inserted into the material in a single process and using the self-tapping thread at the screw shaft a form-fitting connection may be created between the anchor screw and the material limiting the bore hole.

A self-drilling anchor screw is known from U.S. Pat. No. 5,190,425. The anchor screw comprises a screw shaft and a drilling head is arranged at the frontal end of the screw shaft. Further, the screw shaft is provided with a self-tapping thread and the diameter of the screw shaft in the area of the self-tapping thread, without said self-tapping thread, is essentially equivalent to the diameter of the drilling head.

EP 1 760 331 A2 shows a fastening element for hard surfaces, such as concrete walls or the like, comprising a cylindrical base body, with at least sectionally a self-cutting thread being provided at its exterior and which has a first end with a base section as well as a second end facing away from the first end, with the base body showing an interior engagement structure for a placement tool and an accept open towards the second end, provided with a load-engaging means, with the accept following the engaging structure in the direction of the second end, with the engaging structure being embodied as a continuous opening in the base section.

### BRIEF SUMMARY OF THE INVENTION

A self-tapping anchor screw is provided which includes a frontal end, a rear end, a drill head embodied at the frontal end of the screw shaft, and a self-tapping thread to fasten the anchor screw in a bore hole implemented by the drilling head. The anchor screw also includes a fastening element as a separate component and the self-tapping thread is embodied at the fastening element.

### BRIEF DESCRIPTION OF THE DRAWINGS

In the following, exemplary embodiments of the invention are described in greater detail with reference to the attached drawings. They show:

FIG. 1 is a side view of a screw shaft in a first embodiment and a fastening element in a longitudinal cross-section.

FIG. 2 is a cross-section of the screw shaft and the fastening element according to FIG. 1.

FIG. 3 is a side view of the screw shaft in a second exemplary embodiment and the fastening element in a longitudinal cross-section.

### DETAILED DESCRIPTION OF THE INVENTION

One or more embodiments of the present invention provide an anchor screw and a method for fastening an anchor screw, in which the anchor screw may be fastened reliably, cost-effectively, and with little technical expense. This is attained in a self-drilling anchor screw for use in mining, tunnel construction, above-ground and below-ground construction, and for screwing into rock or a building, comprising a screw shaft showing a frontal end and a rear end, a drilling head embodied at the frontal end of the screw shaft, a self-tapping thread to fasten the anchor screw in a bore hole inserted with the drilling head, with the anchor screw comprising a fastening element as a separate component to complement the screw shaft, and the self-cutting thread is embodied at the fastening element. The self-tapping thread is here embodied at a separate component, decoupled from the screw shaft. This way, advantageously self-cutting threads may be provided using a single screw shaft for various materials by only a different fastening element being pushed onto or arranged at the screw shaft. Further it is also possible here that due to the embodiment as a separate component the fastening element is axially displaceable in reference to the screw shaft.

In another embodiment the fastening element is supported on the screw shaft in an axially displaceable fashion. In an embodiment of the self-tapping thread at the screw shaft, using said self-tapping screw the anchor screw may only insufficiently be fastened in the material limiting the bore hole. When drilling the bore hole with a self-drilling anchor screw the axial drilling motion depends on various circumstances, particularly the adjacent rock. Usually, here the axial motion of the screw shaft during drilling is different from the required axial motion due to the pitch of the self-tapping thread. This way, in prior art differences have developed in the required axial motion due to the pitch of the self-tapping thread and the actual axial speed due to the drilling progression caused by the drilling head. Here, in prior art the self-tapping thread may act such that it moves the material in the direction towards the mouth of the bore hole and thus reduces the hardness of the material in the area of the self-tapping thread and a connection of poorer quality develops between the self-tapping thread and the material.

In a decoupling according to one or more embodiments of the invention with separate components of the fastening elements with the self-tapping thread, which rests axially displaceable on the screw shaft, the fastening element with the self-tapping thread may be axially screwed in or inserted into the material with the self-tapping thread according to the pitch of the self-tapping thread.

In an additional variant the fastening element, particularly formed as a sheath, is formed with an opening, with the self-tapping thread being arranged inside the opening of the screw shaft, and at the outside of the fastening element.

In another embodiment a torque may be transferred from the screw shaft to the fastening element, particularly by a form-fitting connection between the fastening element at the opening and the screw shaft. In order to set the fastening element into a rotary motion about a rotary axis as a longitudinal axis of the screw shaft here the crew shaft may be set into a rotary motion and this is transferred to the fastening element so that this way the fastening element is screwed into the bore hole.

Beneficially at least one gliding surface is embodied at the fastening element each at the opening and at the screw shaft, contacting each other and causing an axial glide-bearing of the fastening element at the screw shaft and preferably the respectively at least one gliding surface forms the form-fitting connection to additionally transfer the torque.

In another embodiment the opening of the fastening element comprises at least one longitudinal groove and a clear space forms between at least one longitudinal groove and the fastening element to guide drilling material and/or rinsing fluid through it. This way, advantageously drilling material or rinsing fluid may be conveyed through the longitudinal groove during the drilling process from the area of the drilling head to the mouth of the bore hole and/or rinsing fluid from the mouth of the bore hole to the drilling head or vice versa.

Preferably, the exterior diameter of the fastening element without the self-tapping thread is equivalent or smaller than the maximum diameter of the drilling head. Beneficially the exterior diameter of the fastening element without the self-tapping thread is smaller by less than 20, 10, 5, 3, 2, or 1% than the maximum diameter of the drilling head. The self-tapping thread therefore cuts into the material not processed by the drilling head.

In another embodiment the screw shaft at the outside is provided with a profiling to convey the drilling material during the drilling process from the drilling head to the mouth of the bore hole and preferably the profiling is embodied helically, particularly in the form of a partial screw.

In a supplementary variant the screw shaft is divided into a first section in the area of the frontal end and into a second section in the area of the rear end and the screw shaft shows at the first section a smaller diameter than at the second section so that a fastening element in an axial arrangement at the first section shows no form-fitting connection to the screw shaft. In an axial motion to screw in the fastening element therefore no-form-fitting connection with the screw shaft exists at the first section and thus no torque may be transmitted from the screw shaft at the first section to the fastening element. In a detachable connection of the screw shaft to the drilling head hereby, for example using a screw connection, the screw shaft may be screwed out of the drilling head and subsequently a different screw shaft may be inserted and connected to the drilling head, for example via a screw connection or a bayonet connection.

In particular the screw shaft may be embodied with a solid or hollow cross-section and/or an anchor head is embodied as the rear end of the screw shaft and/or the diameter of the fastening element with the self-tapping thread is greater than the maximum diameter of the drilling head so that with the fastening element screwed in the drilling head and thus also the screw shaft connected to said drilling head may be fastened axially in the bore hole. Preferably a polygonal shape is formed at the anchor head in order to this way allowing to apply a torque using a drilling tool upon the anchor head and thus also the screw shaft in order to move the screw shaft.

A method according to one or more embodiments of the invention to fasten an anchor screw, particularly with the anchor screw described in this application, comprising the steps: implementing a bore hole with a drilling head embodied at a screw shaft, fastening the anchor screw with a self-tapping thread at the anchor screw in said bore hole, with the self-tapping thread during the screwing process performing an axial motion in reference to the screw shaft in the material limiting the bore hole in the direction to a frontal end of the screw shaft.

In another embodiment, during the process of screwing in the self-tapping thread, the thread cuts into the material limiting the bore hole, e.g., rock or concrete, and/or a form-fitting connection is created between the thread and the material limiting the bore hole and/or the self-tapping thread is embodied at a fastening element as a separate part of the screw shaft and the fastening element performs an axial motion in reference to the screw shaft in the direction towards a frontal end of the screw shaft.

In another variant during the drilling process with the drilling head the self-tapping thread is screwed in into the material limiting the bore hole and preferably the fastening element performs the rotary motion of the screw shaft in order to drill with the drilling head due to a connection between the screw shaft and the fastening element, which transfers a torque from the screw shaft to the fastening element.

In another embodiment, after the preferably partial implementation of the bore hole by the drilling head, the self-tapping thread is screwed into the material limiting the bore hole.

Beneficially the fastening element with the self-tapping thread is axially moved to the drilling head or at a distance of less than 10 cm, 5 cm, or 2 cm from the drilling head during the screwing process into the material limiting the bore hole and/or the drilling head contacts the screwed in fastening element so that the drilling head and thus also the screw shaft is fastened axially to the fastening element in the bore hole.

In another embodiment the screw shaft with the screw head is bored manually or using a drilling device into the material.

In another variant the screw shaft with the screw head is drilled into the material by way of rotation and/or percussion drilling and/or rinsed with a liquid or air, or under a vacuum.

In another embodiment, at the beginning of the drilling process of the screw shaft by the drilling head the fastening element is axially arranged in the area of the rear end of the screw shaft so that at the beginning of the drilling process the self-tapping thread at the fastening element screws not into the material limiting the bore hole.

In another embodiment, only after a partial drilling or after a complete drilling into the final drilling depth of the screw shaft by the drilling head the fastening element cuts with the self-tapping thread into the material limiting the bore hole, because the fastening element at the beginning of the drilling process is arranged axially in the area of the rear end of the screw shaft axially at said screw shaft and only thereafter the fastening element moves axially in the direction towards the frontal end of the screw shaft.

In another variant only after a drilling of the screw shaft with the drilling head the fastening element is placed onto the screw shaft and screwed in manually or by a machine.

In an additional embodiment, after the drilling of the screw shaft with the drilling head, a curable fixation material, e.g., resin or cement, is inserted into a space between the anchor screw and the material limiting the bore hole. This way, the support strength of the anchor screw may be further improved by an injection method.

Preferably the curable fixation material may also be inserted through a longitudinal channel in the form of a hollow cross-section at the screw shaft during the formation of the screw shaft.

Beneficially the anchor screw is made at least partially, particularly completely from metal, e.g., steel, or preferably fiber-reinforced plastic, e.g., GFK.

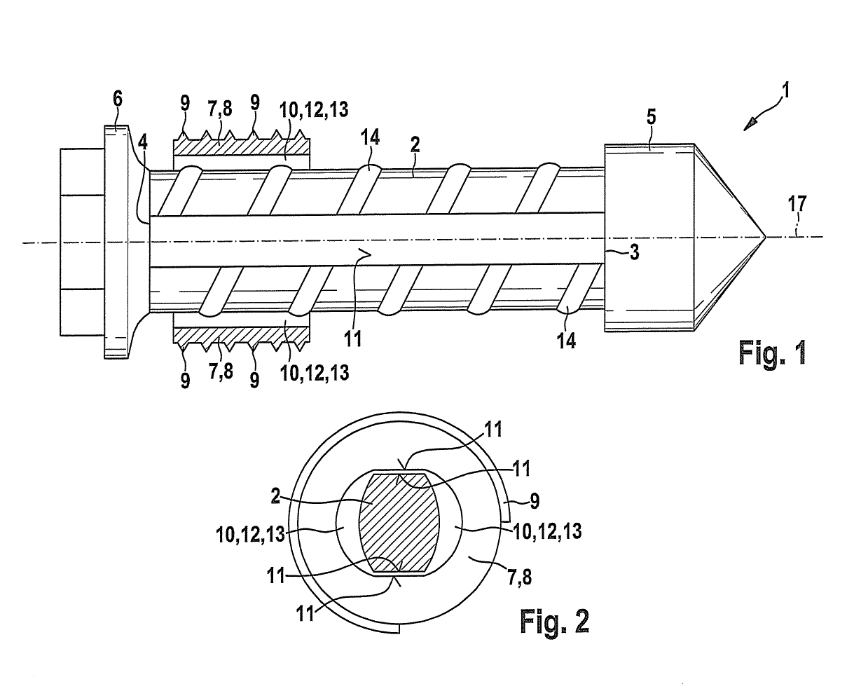

A self-drilling anchor screw 1, shown in FIGS. 1 and 2 in a first exemplary embodiment, serves to fasten an object with the help of the anchor screw 1. The anchor screw 1 is used, for example in above-ground construction, in order to fasten objects at concrete walls or ceilings or in mining in order to also fasten an object in the adjacent rock in the tunnel.

The anchor screw 1 comprises a screw shaft 2 as a solid cross-section on a frontal end 3 and a rear end 4. A drilling head 5 is fastened at the frontal end 3 at the screw shaft 2 and an anchor head 6 is fastened at the rear end 4 of the screw shaft 2.

A fastening element 7 embodied as a sheath 8 comprises an opening 10. The fastening element 7 is pushed onto the screw shaft 2 (FIGS. 1 and 2) so that this way the screw shaft 2 is arranged inside the opening 10 of the fastening element 7. The fastening element 7 is provided at its radial outside with a self-tapping thread 9. The opening 10 is further provided with two planar gliding surfaces 11 and the screw shaft 2 also shows two planar gliding areas 11. The two gliding surfaces 11 at the screw shaft 2 contact the two gliding surfaces 11 at the opening 10 of the fastening element 7 so that here a form-fitting connection exists to transfer a torque from the screw shaft 2 to the fastening element 7. The fastening element 7 further comprises two longitudinal grooves 12 so that two clear spaces 13 develop between the fastening element 7 and the screw shaft 2. Drilling material or rinsing fluid may be conducted through these clear spaces 13. Further, the screw shaft 2 is provided externally with a helical profiling 14 outside the two gliding surfaces 11. Using the profiling 14, drilling material may be conveyed from the drilling head 5 in the direction to the rear end 4 and/or a mouth of the bore hole of a bore to be inserted using the drilling head 5.

In order to fasten the self-drilling anchor screw 1, for example in a concrete wall or adjacent rock in a tunnel, using the drilling device a torque is applied upon the anchor head 6 and thus the anchor head 6, the screw shaft 2, and the drilling head 5 are made to rotate about the longitudinal axis 17 of the screw shaft 2. This way, a bore hole is implemented in the material using the drilling head 5 and at the beginning of the drilling process no contact exists between the fastening element 7 and the material in which the bore hole is inserted, because at the beginning of the drilling process the fastening element 7 is arranged in the area of the rear end 4 of the screw shaft 2, for example contacting the anchor head 6. Only when a predetermined bore depth is reached contact occurs between the fastening element 7 and the material limiting the bore hole. Here, the fastening element 7 performs the drilling and/or rotational movement about the screw shaft 2 of the longitudinal axis 17, due to the form-fitting connection of the two gliding surfaces 11. The self-tapping thread 9 therefore cuts, independent from the drilling progression and/or the axial motion during the drilling with the drilling head 6, only based on the pitch of the self-tapping thread 9 into the material and the fastening element 7 moves in the axial direction towards the drilling head 5 and/or the frontal end 3 of the screw shaft 2 until the fastening element 7 rests on the drilling head 5. After or shortly before the contact of the fastening structure 7 with the drilling head 5 the drilling device is switched off and thus the screw shaft 2 and the fastening element 7 no longer perform any rotary motion. The fastening element 7 creates with the self-tapping thread 9 a form-fitting connection between the material limiting the bore hole and the self-tapping thread 9. An axial motion in the direction towards the mouth of the bore hole is here excluded for the screw shaft 2 because the screw shaft 2 is connected fixed to the drilling head 5 and the drilling head 5 axially contacts the fastening element 7 (not shown). This way the anchor screw 1 is anchored fixed in the bore hole.

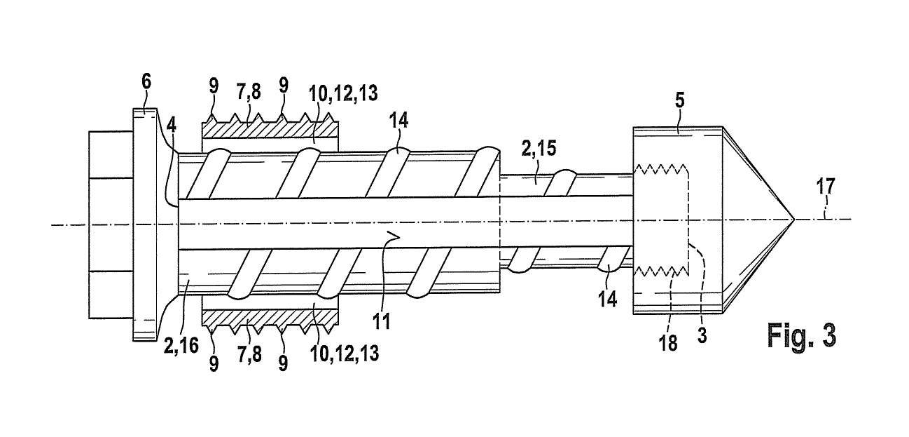

In FIG. 3 a second exemplary embodiment of the screw shaft 2 and/or the anchor screw 1 is shown. In the following, essentially only the differences from the first exemplary embodiment according to FIG. 1 are described. The screw shaft 2 is divided into a first section 15 and into a second section 16. The first section 15 shows a smaller diameter than the second section 16, so that no form-fitting connection develops at the first section 15 at the two gliding areas 11 between the screw shaft 2 and the fastening element 7. The screw shaft 2 is detachably connected to the drilling head 5 by a connection device, for example a screw connection 18 or a bayonet connection. After the bore hole has been inserted using the drilling head 5 and the fastening element 7 has moved completely to the first section 15 at the drilling head 5 and the contact of the fastening element 7 at the drilling head 5 here the screw shaft 2 may be set into a rotary motion without the fastening structure 7 performing a rotary motion as well and the screw shaft 2 may be released using the screw connection 18 from the drilling head 5 and subsequently another screw shaft 2 may be screwed in and fastened in the drilling head 5. Here, the screw shaft 2 may also be embodied as a drilling rod for inserting a bore hole using the drilling head 5 and only subsequently a screw shaft 2, for example showing a different length, is fastened at the drilling head 5 using the screw connection 18 and thus ultimately also the screw shaft 2 is fastened with the fastening element 7 in the bore hole.

Overall, the use of the anchor screw 1 according to one or more embodiments of the invention offers advantages. Due to the embodiment of the self-tapping thread 9 at a separate fastening element 7 in addition to the screw shaft 2, during the cutting process of the self-tapping screw 9 into the material limiting the bore hole the self-tapping screw 9 may perform the axial motion based on the pitch of the self-tapping thread 9, which predetermines the pitch of the self-tapping thread 9. This way, a particularly secure, reliable, and strong force compensating form-fitting connection develops between the self-tapping thread 9 and the material for the self-drilling anchor screw 1. Further, at an identical screw shaft 2 with a drilling head 5 different fastening elements 7 with respectively adjusted self-tapping threads 9 may be pushed thereon for different materials. This way, using the anchor screw 1, the connection between the self-tapping thread 9 and the material may be additionally improved.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A self-drilling anchor screw comprising
a screw shaft showing a frontal end and a rear end;
a drilling head embodied at the frontal end of the screw shaft; and
a self-tapping thread to fasten the anchor screw in a bore hole inserted using a drilling head,
wherein the anchor screw includes a fastening element as a separate component complementing the screw shaft and the self-tapping thread is embodied at the fastening element.

2. The anchor screw of claim 1 wherein the fastening element is supported on the screw shaft in an axially displaceable fashion.

3. The anchor screw of claim 1 wherein the fastening element, particularly embodied as a sheath, shows an opening, with the screw shaft being arranged inside said opening and the self-tapping thread being formed at the outside of the fastening element.

4. The anchor screw of claim 1 wherein a torque may be transmitted from the screw shaft to the fastening element, particularly by a form-fitting connection between the fastening element at the opening and the screw shaft.

5. The anchor screw of claim 1 wherein at least one gliding area is embodied at the fastening element at the opening and at the screw shaft, each resting on one another, and causing an axial mounting by pure bearing of the fastening element at the screw shaft and preferably at least one gliding area each additionally forming the form-fitting connection to transmit the torque.

6. The anchor screw of claim 3 wherein the opening of the fastening element comprises at least one longitudinal groove and that a clear space forms between at least one longitudinal groove and the fastening element to guide at least one of drilling material and rinsing fluid.

7. The anchor screw of claim 1 wherein the exterior diameter of the fastening element without the self-tapping thread is of equal or smaller size than the maximum diameter of the drilling head.

8. The anchor screw of claim 1 wherein the screw shaft is provided at the outside with a profiling to convey the drilling material during the drilling process from the drilling head to the mouth of the bore hole.

9. The anchor screw of claim 8 wherein the profiling is embodied helically.

10. The anchor screw of claim 1 wherein the screw shaft is divided into a first section in the area of the frontal end and into a second section in the area of the rear end and the screw shaft comprises at the first section a smaller diameter than at the second section so that the fastening element in an axial arrangement at the first section shows no form-fitting connection to the screw shaft.

11. The anchor screw of claim 1 wherein the diameter of the fastening element with the self-tapping thread is greater than the maximum diameter of the drilling head so that the drilling head with the fastening element screwed in and thus also the screw shaft connected to the drilling head may be axially fastened in the bore hole.

12. A method for fastening an anchor screw, said method including:
implementing a bore hole with a drilling head embodied at a screw shaft; and
fastening the anchor screw to a self-tapping thread of the anchor screw in the bore hole,
wherein the self-tapping thread performs an axial motion during the screwing process into the material limiting the bore hole in reference to the screw shaft in the direction towards a frontal end of the screw shaft.

13. The method of claim 12 wherein during the screwing process of the self-tapping thread said thread cuts into the material limiting the bore hole.

14. The method of claim 12 wherein the self-tapping thread is embodied at a fastening structure as a separate component of the screw shaft and the fastening structure performs an axial motion in reference to the screw shaft in the direction towards a frontal end of the screw shaft.

15. The method of claim 12 wherein during the drilling with the drilling head the self-tapping thread is screwed into the material limiting the bore hole and the fastening element performs the rotary motion of the screw shaft to drill with the drilling head, due to a connection between the screw shaft and the fastening element, which transfers a torque from the screw shaft to the fastening element.

16. The method of claim 12 wherein the self-tapping thread is screwed in after the at least partial implementation of the bore hole with the drilling head into the material limiting the bore hole.

17. The method of claim 12 wherein the fastening element is moved with the self-tapping thread axially to the drilling head.

18. The method of claim 12 wherein the fastening element is moved with the self-tapping thread a distance of less than 10 cm from the drilling head when screwing into the material limiting the bore hole.

19. The method of claim 12 wherein the drilling head contacts the fastening structure screwed so that the drilling head and thus also the screw shaft is axially fastened with the fastening structure in the bore hole.
